(19) United States
(12) Patent Application Publication
(10) Pub. No.: US 2015/0203039 A1
(43) Pub. Date: Jul. 23, 2015

(54) AUTOMATIC REAR-VIEW MIRROR ADJUSTMENTS

(71) Applicants: David Kaplan, Modi'in (IL); Tomer Rider, Naahryia (IL); Aviv Ron, Nir Moshe (IL); Shahar Taite, kfar saba (IL)

(72) Inventors: David Kaplan, Modi'in (IL); Tomer Rider, Naahryia (IL); Aviv Ron, Nir Moshe (IL); Shahar Taite, kfar saba (IL)

(21) Appl. No.: 14/158,282

(22) Filed: Jan. 17, 2014

(51) Int. Cl. B60R 1/02

(52) U.S. Cl. CPC B60R 1/025

(57) ABSTRACT

Systems and methods may provide for identifying a first position of a rear-view mirror, wherein the first position provides a target field of view. Additionally, a second position may be determined for the rear-view mirror in response to a travel related tilt of the rear-view mirror and the rear-view mirror may be automatically adjusted to the second position, wherein the second position provides the target field of view after the travel related tilt. In one example, the travel related tilt is detected based on one or more sensor signals.

### TECHNICAL FIELD

Embodiments generally relate to rear-view mirrors. More particularly, embodiments relate to automatic rear-view mirror adjustments.

### BACKGROUND

Rear-view mirrors may be provided on various types of vehicles. Conventional rear-view mirrors may be adjusted by the driver based on individual height, seat incline and seat height, in order to achieve a line of sight that enables the driver to see other vehicles and objects behind the driver. As the vehicle begins driving uphill, however, the line of sight provided to by the rear-view mirror may be too low (e.g., looking at the ground) due to the inclined angle of incidence associated with the hill and the fixed position of the rear-view mirror. Similarly, as the vehicle begins driving downhill, the line of sight provided by the rear-view mirror may be too high (e.g., looking at the sky). Accordingly, safety concerns may result from drivers lacking a full view of the road behind them, drivers manually adjusting conventional rear-view mirrors while driving, and so forth.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a line of sight adjustment for uphill and downhill driving according to an embodiment;

FIG. 2 is an illustration of an example of a target field of view adjustment for uphill and downhill driving according to an embodiment;

FIGS. 3A-3C are illustrations of examples of alternative rear-view mirror configurations according to embodiments;

FIG. 4 is a flowchart of an example of a method of operating a rear-view mirror according to an embodiment;

FIG. 5 is a block diagram of an example of a logic architecture according to an embodiment;

FIG. 6 is a block diagram of an example of a processor according to an embodiment; and

FIG. 7 is a block diagram of an example of a system according to an embodiment.

### DESCRIPTION OF EMBODIMENTS

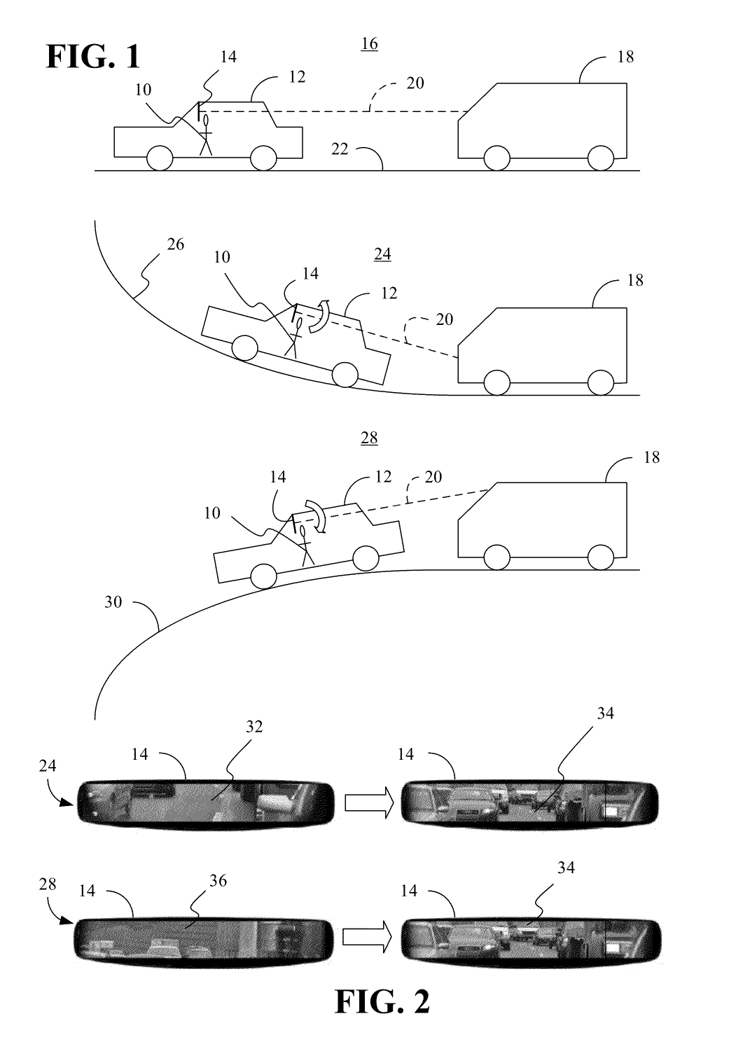

Turning now to FIG. 1, a set of line of sight adjustments is shown for a driver 10 of a vehicle 12 having an automatically adjustable rear-view mirror 14. In an initial scenario 16, the driver has set the rear-view mirror 14 to an initial (e.g., first) position that provides a target field of view of objects behind the vehicle 12 such as, for example, a truck 18. The setting of the initial position of the rear-view mirror 14 may occur, for example, before or after the driver 10 has begun operating the vehicle 12, wherein the initial position may take into consideration the height of the driver 10, the recline angle of the driver seat (not shown), the height of the driver seat, and so forth. In the illustrated example, an initial line of sight 20 associated with the initial position enables the driver to see an optimal portion (e.g., the windshield) of the truck 18 and its surroundings while the vehicle 12 travels on a substantially flat (e.g., horizontal) road 22.

In an uphill scenario 24, however, the vehicle 12 begins traveling on an inclined road 26, which causes the initial line of sight 20 to be too low. For example, the initial line of sight 20 may be of the grille of the truck 18 and/or ground rather than the windshield of the truck 18. Accordingly, the initial position of the rear-view mirror 14 may no longer provide the driver 10 with the optimal target field of view. In the illustrated example, the travel related tilt of the rear-view mirror 14 away from the target field of view causes the rear-view mirror 14 to automatically rotate upward (e.g., counterclockwise in the view shown) to maintain the target field of view for the driver 10. Such an approach may significantly enhance safety to the driver 10 of the vehicle 12 as well as the driver of the truck 18. The illustrated approach may also substantially improve the driving experience.

Similarly, a downhill scenario 28 may involve the vehicle 12 entering a declined road 30, which causes the initial line of sight 20 to be too high. For example, the initial line of sight 20 might be of the roof of the truck 18 and/or sky rather than the windshield of the truck 18. Accordingly, the initial position of the rear-view mirror 14 may no longer provide the driver 10 with the target field of view. In the illustrated example, the travel related tilt of the rear-view mirror 14 away from the target field of view causes the rear-view mirror 14 to automatically rotate downward (e.g., clockwise in the view shown) to maintain the target field of view for the driver 10. As already noted, such an approach may significantly enhance safety and improve the overall driving experience.

FIG. 2 shows the results of automated adjustments from the perspective of a driver such as, for example, the driver 10 (FIG. 1). In the illustrated example, the uphill scenario 24 demonstrates that the rear-view mirror 14 provides an inclined field of view 32 when the vehicle begins inclined travel on a road such as, for example, the inclined road 26 (FIG. 1). In that scenario, the rear-view mirror 14 automatically rotates upward to provide the target field of view 34. Similarly, the downhill scenario 28 demonstrates that the rear-view mirror 14 may provide a declined field of view 36 when the vehicle begins declined travel on a road such as, for example, the declined road 30 (FIG. 1). In that scenario, the rear-view mirror 14 automatically rotates downward to provide the target field of view 34.

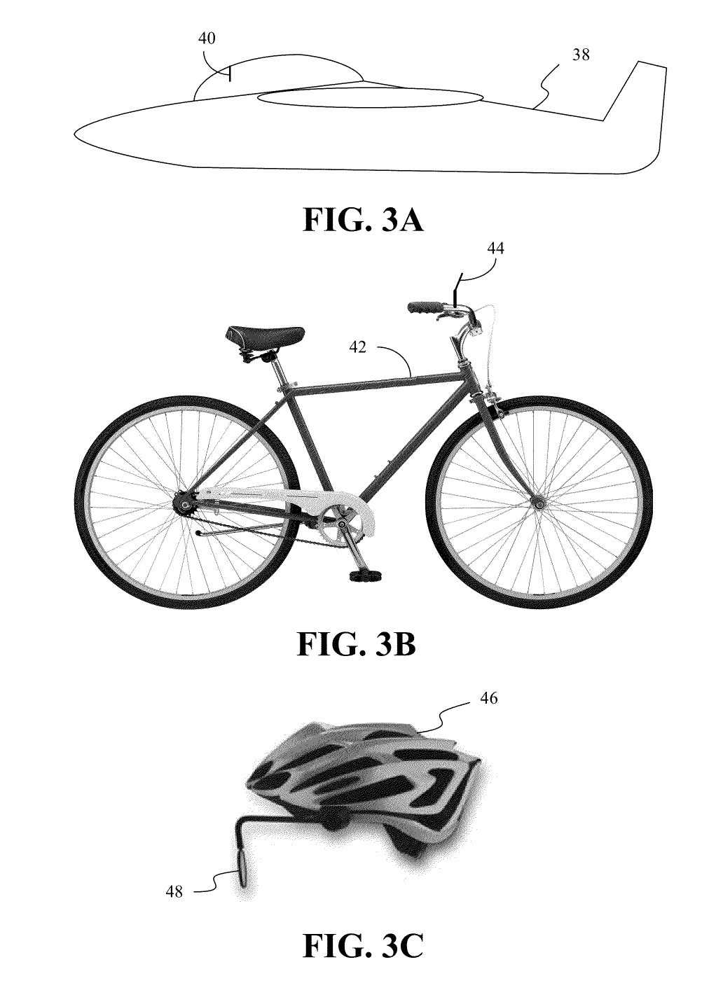

FIGS. 3A-3C demonstrate that an automatically rotating rear-view mirror may be implemented in a wide variety of settings. For example, FIG. 3A shows an airplane 38 that includes a rear-view mirror 40, wherein the detection of inclined travel (e.g., climb) may cause the rear-view mirror 40 to rotate upward in order to enable the pilot (not shown) of the airplane 38 to continue to see the target field of view behind the airplane 38 (e.g., other fighter jets, etc.). Similarly, the detection of declined travel (e.g., dive) may cause the rear-view mirror 40 to rotate downward in order to enable the pilot of the airplane 38 to continue to see the target field of view.

Additionally, FIG. 3B shows a bicycle 42 that includes a rear-view mirror 44, wherein the detection of inclined travel (e.g., uphill pedaling) may cause the rear-view mirror 44 to rotate upward in order to enable the operator (not shown) of the bicycle 42 to continue to see the target field of view behind the bicycle 42 (e.g., other cyclists, vehicles, etc.). Similarly, the detection of declined travel (e.g., downhill pedaling) may cause the rear-view mirror 44 to rotate downward in order to enable the operator of the bicycle 42 to continue to see the target field of view.

In yet another example, FIG. 3C shows a helmet 46 that includes a rear-view mirror 48, wherein the detection of inclined travel (e.g., uphill travel) may cause the rear-view mirror 48 to rotate upward in order to enable the wearer (not shown) of the helmet 46 to continue to see the target field of view behind the helmet 46 (e.g., other cyclists, vehicles, etc.). Similarly, the detection of declined travel (e.g., downhill travel) may cause the rear-view mirror 48 to rotate downward in order to enable the wearer of the helmet 46 to continue to see the target field of view.

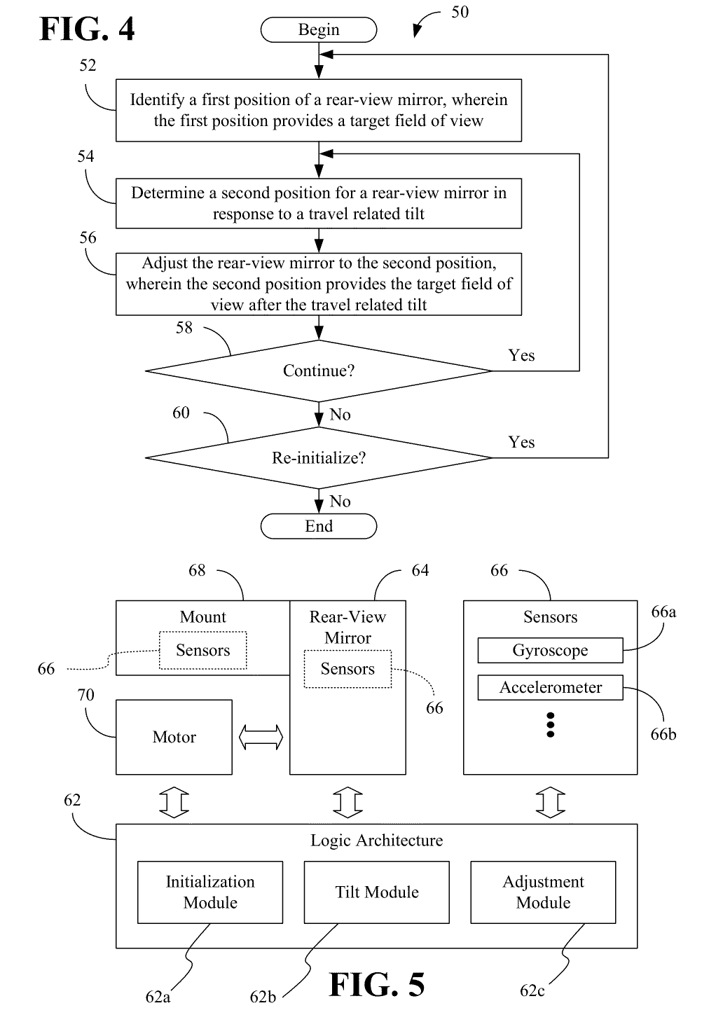

Turning now to FIG. 4, a method 50 of operating a rear-view mirror is shown. The method 50 may be implemented as a module in set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 50 may be written in any combination of one or more programming languages, including an object oriented programming language such as Java, Smalltalk, C++ or the like and conventional procedural programming languages, such as the “C” programming language or similar programming languages.

Illustrated processing block 52 provides for identifying a first position of a rear-view mirror, wherein the first position provides a target field of view. Block 52 may involve, for example, registering a “home” position of the rear-view mirror in accordance with an initialization process conducted by a driver, pilot, cyclist or other individual using the rear-view mirror to observe objects behind the individual. A second position may be determined for the rear-view mirror at block 54 in response to a travel related tilt of the rear-view mirror. As will be discussed in greater detail, detecting the travel related tilt may involve receiving and processing one or more sensor signals, wherein the sensors generating the sensor signals may include, for example, gyroscopes, accelerometers, pressure sensors, etc., or any combination thereof. Moreover, the sensors may be coupled to the rear-view mirror itself, a mount associated with the rear-view mirror, a vehicle associated with the rear-view mirror, etc., or any combination thereof.

Illustrated block 56 adjusts the rear-view mirror to the second position, wherein the second position provides the target field of view after the travel related tilt. For example, adjusting the rear-view mirror might include automatically rotating the rear-view mirror upward if the travel related tilt is the result of inclined travel, automatically rotating the rear-view mirror downward if the travel related tilt is the result of declined travel, and so forth. Adjusting the rear-view mirror might include controlling, for example, a servo motor physically coupled to the rear-view mirror in order to automatically rotate, slide, pan or otherwise move the rear-view mirror to the second position. A determination may be made at block 58 as to whether the adjustment loop is to continue. If so, the position determination at block 54 and the mirror adjustment at block 56 may repeat on a continual basis. The determination at block 58 may take into consideration various factors such as, for example, user preferences, vehicle state (e.g., stationary versus mobile), and so forth. Block 60 may provide for determining whether the rear-view mirror is to be re-initialized. If so, the first position determination at block 52 may be repeated in order to determine the target field of view.

Turning now to FIG. 5, a logic architecture 62 (62a-62c) is shown, wherein the logic architecture 62 may generally implement one or more aspects of the method 50 (FIG. 4), already discussed in a system such as, for example, an in-vehicle infotainment (IVI) system. In the illustrated example, an initialization module 62a identifies a first (e.g., “home”) position of a rear-view mirror 64 such as, for example, the rear-view mirror 14 (FIGS. 1 and 2), the rear-view mirror 40 (FIG. 3A), the rear-view mirror 44 (FIG. 3B), the rear-view mirror 48 (FIG. 3C), and so forth. The first position of the rear-view mirror 64 may provide a target field of view, as already discussed. The illustrated architecture 62 also includes a tilt module 62b that detects travel related tilts of the rear-view mirror 64 based on one or more sensor signals from one or more sensors 66 (66a-66b).

The sensors 66 may include, for example, a gyroscope 66a, an accelerometer 66b, etc., or any combination thereof. For example, if the tilt module 62b receives a signal from the gyroscope 66a, the tilt module 62b may integrate the sensor signal to determine an angle of the travel related tilt. In this regard, the signal from the gyroscope 66a may indicate angular velocity (e.g., w). Therefore, integrating the signal from the gyroscope 66a may provide the tilt angle (e.g., 0) according to the below expressions.

ω=dθ/dt (1)

θ=∫ω·dt (2)

Thus, the tilt angle resulting from the travel related tilt of the rear-view mirror 64 may be compared to the tilt angle associated with the first/home position that originally provided the target field of view, wherein the difference between those two values may effectively quantify the amount of adjustment to be made to the rear-view mirror 64 in order to provide the user with the target field of view after the travel related tilt occurs.

If the tilt module 62b receives a signal from the accelerometer 66b, the tilt module may use the signal from the accelerometer 66b to determine the tilt angle and/or adjust for drift. In this regard, the signal from the gyroscope 66a may represent an absolute value that might drift over time. Accordingly, the two signals from the gyroscope 66a and the accelerometer 66b may be combined (with appropriate filtering—e.g., low pass filtering of the accelerometer signal and high pass filtering of the integrated gyroscope signal) to improve accuracy and/or performance. Other sensors, sensor hubs, signal processing techniques and/or filtering approaches may be used to quantify the travel related tilt.

The illustrated architecture 62 also includes an adjustment module 62c to adjust the rear-view mirror 64 to the second position, wherein the second position provides the target field of view after the travel related tilt. For example, the adjustment module 62c may use a motor 70 (e.g., servo motor) that is mechanically coupled to the rear-view mirror 64 in order to manipulate the rear-view mirror 64 so that the tilt angle is driven back to zero relative to the first/home position. Thus, if the tilt angle of the rear-view mirror 64 was 90° relative to horizontal at the home position and the travel related tilt has resulted in the tilt angle of the rear-view mirror 64 being increased to 135° (e.g., inclined travel of 45°), the adjustment module 62c might use the motor 70 to drive the rear-view mirror 64 45° in the positive direction. An example of such an automatic adjustment may be reflected in an uphill scenario such as, for example, the uphill scenario 24 (FIGS. 1 and 2).

If, on the other hand, the tilt angle of the rear-view mirror was 90° relative to horizontal at the home position and the travel related tilt has resulted in the tilt angle of the rear-view mirror 64 being decreased to 45° (e.g., declined travel of 45°), the adjustment module 62c may use the motor 70 to drive the rear-view mirror 64 45° in the negative direction. An example of such an automatic adjustment may be reflected in a downhill scenario such as, for example, the downhill scenario 28 (FIGS. 1 and 2). The sensors 66 may generally be coupled to the rear-view mirror 64, coupled to a mount 68 of the rear-view mirror 64, positioned elsewhere on the vehicle, etc., or any combination thereof. If the sensors 66 are coupled to the rear-view mirror 64, the sensor signals may be used for feedback during the mirror adjustment process.

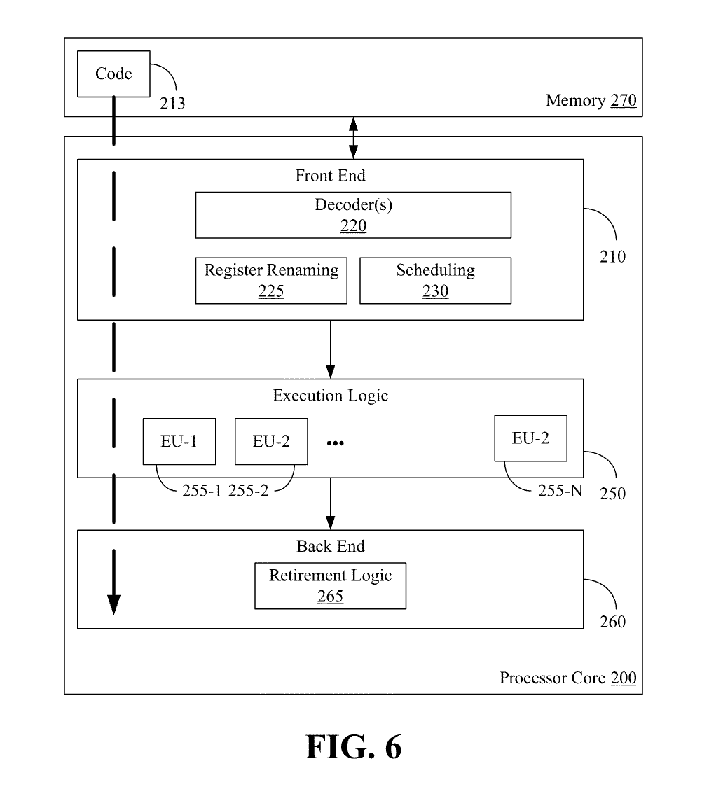

FIG. 6 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 6, a processing element may alternatively include more than one of the processor core 200 illustrated in FIG. 6. The processor core 200 may be a single-threaded core or, for at least one embodiment, the processor core 200 may be multithreaded in that it may include more than one hardware thread context (or “logical processor”) per core.

FIG. 6 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 50 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 6, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

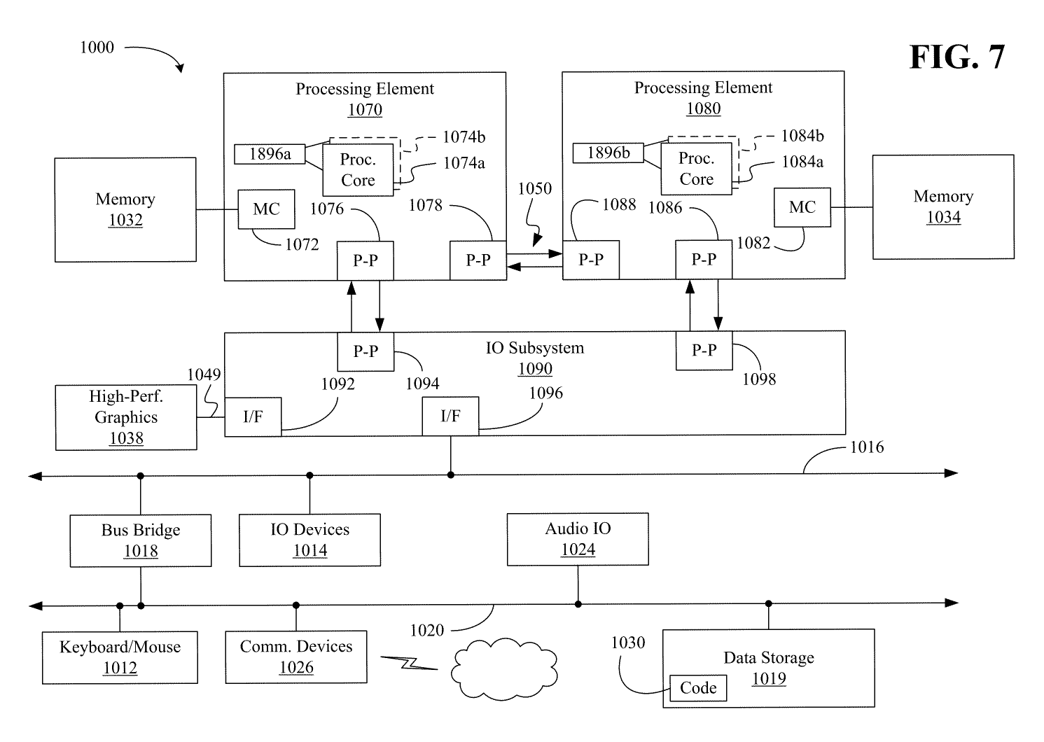

Referring now to FIG. 7, shown is a block diagram of a system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 50 (FIG. 4), already discussed, and may be similar to the code 213 (FIG. 6), already discussed. Further, an audio I/O 1024 may be coupled to second bus 1020.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

### Additional Notes and Examples

Example 1 may include a system to control rear-views, comprising one or more sensors, a rear-view mirror, a motor coupled to the rear-view mirror, an initialization module to identify a first position of the rear-view mirror, wherein the first position is to provide a target field of view, a tilt module to detect a travel related tilt of the rear-view mirror based on one or more sensor signals from the one or more sensors and determine a second position for the rear-view mirror in response to the travel related tilt, and an adjustment module to adjust the rear-view mirror to the second position, wherein the second position is to provide the target field of view after the travel related tilt.

Example 2 may include the system of Example 1, wherein at least one of the one or more sensors is coupled to one of the rear-view mirror, a mount associated with the rear-view mirror or a vehicle associated with the rear-view mirror.

Example 3 may include the system of Example 1, wherein at least one of the one or more sensors includes a gyroscope, wherein the tilt module is to receive a sensor signal from the gyroscope and integrate the sensor signal from the gyroscope to determine an angle of the travel related tilt, and an accelerometer, wherein the tilt module is to receive a sensor signal from the accelerometer and use the sensor signal from the accelerometer to compensate for drift.

Example 4 may include the system of any one of Examples 1 to 3, wherein the tilt module is to automatically rotate the rear-view mirror upward if the travel related tilt is a result of inclined travel and automatically rotate the rear-view mirror downward if the travel related tilt is a result of declined travel.

Example 5 may include a method of operating a rear-view mirror, comprising identifying a first position of the rear-view mirror, wherein the first position provides a target field of view, determining a second position for the rear-view mirror in response to a travel related tilt of the rear-view mirror and adjusting the rear-view mirror to the second position, wherein the second position provides the target field of view after the travel related tilt.

Example 6 may include the method of Example 5, further including detecting the travel related tilt based on one or more sensor signals.

Example 7 may include the method of Example 6, further including receiving the one or more sensor signals from a sensor coupled to one of the rear-view mirror, a mount associated with the rear-view mirror or a vehicle associated with the rear-view mirror.

Example 8 may include the method of Example 6, further including receiving at least one of the one or more sensor signals from a gyroscope, and integrating the at least one of the one or more sensor signals to determine an angle of the travel related tilt.

Example 9 may include the method of Example 6, further including receiving at least one of the one or more sensor signals from an accelerometer, and using the at least one of the one or more sensor signals to compensate for drift.

Example 10 may include the method of any one of Examples 5 to 9, wherein adjusting the rear-view mirror includes automatically rotating the rear-view mirror upward if the travel related tilt is a result of inclined travel.

Example 11 may include the method of any one of Examples 5 to 9, wherein adjusting the rear-view mirror includes automatically rotating the rear-view mirror downward if the travel related tilt is a result of declined travel.

Example 12 may include at least one computer readable storage medium comprising a set of instructions which, when executed by a computing device, cause the computing device to identify a first position of the rear-view mirror, wherein the first position is to provide a target field of view, determine a second position for the rear-view mirror in response to a travel related tilt of the rear-view mirror and adjust the rear-view mirror to the second position, wherein the second position is to provide the target field of view after the travel related tilt.

Example 13 may include the at least one computer readable storage medium of Example 12, wherein the instructions, when executed, cause a computing device to detect the travel related tilt based on one or more sensor signals.

Example 14 may include the at least one computer readable storage medium of Example 13, wherein the instructions, when executed, cause a computing device to receive the one or more sensor signals from a sensor coupled to one of the rear-view mirror, a mount associated with the rear-view mirror or a vehicle associated with the rear-view mirror.

Example 15 may include the at least one computer readable storage medium of Example 13, wherein the instructions, when executed, cause a computing device to receive at least one of the one or more sensor signals from a gyroscope, and integrate the at least one of the one or more sensor signals to determine an angle of the travel related tilt.

Example 16 may include the at least one computer readable storage medium of Example 13, wherein the instructions, when executed, cause a computing device to receive at least one of the one or more sensor signals from an accelerometer, and use the at least one of the one or more sensor signals to compensate for drift.

Example 17 may include the at least one computer readable storage medium of any one of Examples 12 to 16, wherein the instructions, when executed, cause a computing device to automatically rotate the rear-view mirror upward to adjust the rear-view mirror to the second position if the travel related tilt is a result of inclined travel.

Example 18 may include the at least one computer readable storage medium of any one of Examples 12 to 16, wherein the instructions, when executed, cause a computing device to automatically rotate the rear-view mirror downward to adjust the rear-view mirror to the second position if the travel related tilt is a result of declined travel.

Example 19 may include an apparatus to adjust a rear-view mirror, comprising an initialization module to identify first position of the rear-view mirror, wherein the first position is to provide a target field of view, a tilt module to determine a second position for the rear-view mirror in response to a travel related tilt of the rear-view mirror and an adjustment module to adjust the rear-view mirror to the second position, wherein the second position is to provide the target field of view after the travel related tilt.

Example 20 may include the apparatus of Example 19, wherein the tilt module is to detect the travel related tilt based on one or more sensor signals.

Example 21 may include the apparatus of Example 20, wherein the tilt module is to receive the one or more sensor signals from a sensor coupled to one of the rear-view mirror, a mount associated with the rear-view mirror or a vehicle associated with the rear-view mirror.

Example 22 may include the apparatus of Example 20, wherein the tilt module is to receive at least one of the one or more signals from a gyroscope and integrate the at least one of the one or more sensor signals to determine an angle of the travel related tilt.

Example 23 may include the apparatus of Example 20, wherein the tilt module is to receive at least one of the one or more signals from an accelerometer and use the at least one of the one or more sensor signals to compensate for drift.

Example 24 may include the apparatus of any one of Examples 19 to 23, wherein the tilt module is to automatically rotate the rear-view mirror upward if the travel related tilt is a result of inclined travel.

Example 25 may include the apparatus of any one of Examples 19 to 23, wherein the tilt module is to automatically rotate the rear-view mirror downward if the travel related tilt is a result of declined travel.

Example 26 may include an apparatus to adjust a rear-view mirror, comprising means for identifying a first position of the rear-view mirror, wherein the first position provides a target field of view, means for determining a second position for the rear-view mirror in response to a travel related tilt of the rear-view mirror, and means for adjusting the rear-view mirror to the second position, wherein the second position provides the target field of view after the travel related tilt.

Example 27 may include the apparatus of Example 26, further including means for detecting the travel related tilt based on one or more sensor signals.

Example 28 may include the apparatus of Example 27, further including means for receiving the one or more sensor signals from a sensor coupled to one of the rear-view mirror, a mount associated with the rear-view mirror or a vehicle associated with the rear-view mirror.

Example 29 may include the apparatus of Example 27, further including means for receiving at least one of the one or more sensor signals from a gyroscope, and means for integrating the at least one of the one or more sensor signals to determine an angle of the travel related tilt.

Example 30 may include the apparatus of Example 27, further including means for receiving at least one of the one or more sensor signals from an accelerometer, and means for using the at least one of the one or more sensor signals to compensate for drift.

Example 31 may include the apparatus of any one of Examples 26 to 30, wherein adjusting the rear-view mirror includes automatically rotating the rear-view mirror upward if the travel related tilt is a result of inclined travel.

Example 32 may include the apparatus of any one of Examples 26 to 30, wherein adjusting the rear-view mirror includes automatically rotating the rear-view mirror downward if the travel related tilt is a result of declined travel.

Thus, techniques described herein may therefore enable drivers, pilots, cyclists, etc., to maintain an optimal view of the road and/or objects behind them without manually adjusting rear-view mirrors during travel. Accordingly, a number of safety concerns may be obviated.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system to control rear-views, comprising:
one or more sensors;
a rear-view mirror;
a motor coupled to the rear-view mirror;
an initialization module to identify a first position of the rear-view mirror, wherein the first position is to provide a target field of view;
a tilt module to detect a travel related tilt of the rear-view mirror based on one or more sensor signals from the one or more sensors and determine a second position for the rear-view mirror in response to the travel related tilt; and
an adjustment module to adjust the rear-view mirror to the second position, wherein the second position is to provide the target field of view after the travel related tilt.

2. The system of claim 1, wherein at least one of the one or more sensors is coupled to one of the rear-view mirror, a mount associated with the rear-view mirror or a vehicle associated with the rear-view mirror.

3. The system of claim 1, wherein at least one of the one or more sensors includes:
a gyroscope, wherein the tilt module is to receive a sensor signal from the gyroscope and integrate the sensor signal from the gyroscope to determine an angle of the travel related tilt; and
an accelerometer, wherein the tilt module is to receive a sensor signal from the accelerometer and use the sensor signal from the accelerometer to compensate for drift.

4. The system of claim 1, wherein the tilt module is to automatically rotate the rear-view mirror upward if the travel related tilt is a result of inclined travel and automatically rotate the rear-view mirror downward if the travel related tilt is a result of declined travel.

5. A method of operating a rear-view mirror, comprising:
identifying a first position of the rear-view mirror, wherein the first position provides a target field of view;
determining a second position for the rear-view mirror in response to a travel related tilt of the rear-view mirror; and
adjusting the rear-view mirror to the second position, wherein the second position provides the target field of view after the travel related tilt.

6. The method of claim 5, further including detecting the travel related tilt based on one or more sensor signals.

7. The method of claim 6, further including receiving the one or more sensor signals from a sensor coupled to one of the rear-view mirror, a mount associated with the rear-view mirror or a vehicle associated with the rear-view mirror.

8. The method of claim 6, further including:
receiving at least one of the one or more sensor signals from a gyroscope; and
integrating the at least one of the one or more sensor signals to determine an angle of the travel related tilt.

9. The method of claim 6, further including:
receiving at least one of the one or more sensor signals from an accelerometer; and
using the at least one of the one or more sensor signals to compensate for drift.

10. The method of claim 5, wherein adjusting the rear-view mirror includes automatically rotating the rear-view mirror upward if the travel related tilt is a result of inclined travel.

11. The method of claim 5, wherein adjusting the rear-view mirror includes automatically rotating the rear-view mirror downward if the travel related tilt is a result of declined travel.

12. At least one computer readable storage medium comprising a set of instructions which, when executed by a computing device, cause the computing device to:
identify a first position of the rear-view mirror, wherein the first position is to provide a target field of view;
determine a second position for the rear-view mirror in response to a travel related tilt of the rear-view mirror; and
adjust the rear-view mirror to the second position, wherein the second position is to provide the target field of view after the travel related tilt.

13. The at least one computer readable storage medium of claim 12, wherein the instructions, when executed, cause a computing device to detect the travel related tilt based on one or more sensor signals.

14. The at least one computer readable storage medium of claim 13, wherein the instructions, when executed, cause a computing device to receive the one or more sensor signals from a sensor coupled to one of the rear-view mirror, a mount associated with the rear-view mirror or a vehicle associated with the rear-view mirror.

15. The at least one computer readable storage medium of claim 13, wherein the instructions, when executed, cause a computing device to:
receive at least one of the one or more sensor signals from a gyroscope; and
integrate the at least one of the one or more sensor signals to determine an angle of the travel related tilt.

16. The at least one computer readable storage medium of claim 13, wherein the instructions, when executed, cause a computing device to:
receive at least one of the one or more sensor signals from an accelerometer; and
use the at least one of the one or more sensor signals to compensate for drift.

17. The at least one computer readable storage medium of claim 12, wherein the instructions, when executed, cause a computing device to automatically rotate the rear-view mirror upward to adjust the rear-view mirror to the second position if the travel related tilt is a result of inclined travel.

18. The at least one computer readable storage medium of claim 12, wherein the instructions, when executed, cause a computing device to automatically rotate the rear-view mirror downward to adjust the rear-view mirror to the second position if the travel related tilt is a result of declined travel.

19. An apparatus to adjust a rear-view mirror, comprising:
an initialization module to identify a first position of the rear-view mirror, wherein the first position is to provide a target field of view;
a tilt module to determine a second position for the rear-view mirror in response to a travel related tilt of the rear-view mirror; and
an adjustment module to adjust the rear-view mirror to the second position, wherein the second position is to provide the target field of view after the travel related tilt.

20. The apparatus of claim 19, wherein the tilt module is to detect the travel related tilt based on one or more sensor signals.

21. The apparatus of claim 20, wherein the tilt module is to receive the one or more sensor signals from a sensor coupled to one of the rear-view mirror, a mount associated with the rear-view mirror or a vehicle associated with the rear-view mirror.

22. The apparatus of claim 20, wherein the tilt module is to receive at least one of the one or more signals from a gyroscope and integrate the at least one of the one or more sensor signals to determine an angle of the travel related tilt.

23. The apparatus of claim 20, wherein the tilt module is to receive at least one of the one or more signals from an accelerometer and use the at least one of the one or more sensor signals to compensate for drift.

24. The apparatus of claim 19, wherein the tilt module is to automatically rotate the rear-view mirror upward if the travel related tilt is a result of inclined travel.

25. The apparatus of claim 19, wherein the tilt module is to automatically rotate the rear-view mirror downward if the travel related tilt is a result of declined travel.
